(19) United States
(12) Patent Application Publication
(10) Pub. No.: US 2020/0047289 A1
(43) Pub. Date: Feb. 13, 2020

(54) METHOD FOR PRODUCING A CONNECTION BETWEEN TWO METALLIC COMPONENTS

(71) Applicant: Miba Sinter Austria GmbH, Laakirchen (AT)

(72) Inventors: Daniel Augusto PERUGINI, Salto-SP (BR); Jose Correa NETO, Campinas-SP (BR); Murilo Alves PADILHA, Indaiatuba (BR)

(73) Assignee: Miba Sinter Austria GmbH, Laakirchen (AT)

(21) Appl. No.: 16/452,664

(22) Filed: Jun. 26, 2019

(30) Foreign Application Priority Data
Aug. 10, 2018 (AT) A 50686/2018

(51) Int. Cl. B23K 35/02; B23K 1/00; B22F 1/00; B23K 35/30

(52) U.S. Cl. CPC B23K 35/0244; B23K 1/0002; B22F 2999/00; B23K 35/302; B22F 1/0059

(57) ABSTRACT

The invention relates to a method for producing a connection between a first metallic component (2) and a second metallic component (3), wherein at least one of the two metallic components (2, 3) is powder-metallurgically manufactured from a sintering material and the connection is produced by means of soldering in a connection area (4) formed between the two metallic components (2, 3). The surface (9), which forms a part of the connection area (4), of the metallic component (2 or 3) manufactured from the sintering material is compacted prior to the soldering.

The invention relates to a method for producing a connection between a first metallic component and a second metallic component, wherein at least one of the two metallic components is powder-metallurgically manufactured from a sintering material and the connection is produced by means of soldering in a connection area formed between the two metallic components.

The invention further relates to an assembly comprising a first metallic component and a second metallic component, wherein at least one of the two metallic components is powder-metallurgically manufactured from a sintering material, and the two components are soldered to one another with a solder in a connection area.

Connecting components from sintering materials to one another in a materially bonded manner occasionally reaches the limits of connection strengths that can typically be achieved. This particularly applies to sintering materials that are difficult to process powder-metallurgically, such as stainless steel powder or hard metal powder. Diverse approaches for nevertheless achieving applicable connection strengths have been described in the prior art.

For example, DD 283 160 A5 describes a hard metal alloy consisting of one or several hard material phases of carbides of the metals of subgroups IV., V. and VI. of the PSE, preferably of tungsten carbide, and a binder metal phase of cobalt, nickel or iron or of alloys of these metals with a fraction of 2.5 to 30% by mass, except for austenitic binder metal alloys, wherein the initial powder mixture and/or the hard metal batch contains 0.5 to 5% by mass manganese or manganese oxide. According to the description of this publication, this hard metal alloy is particularly beneficial to use where, on the one hand, surfaces that are free of oxide and not impoverished with binder metals are necessary and, on the other hand, a high level of mechanical properties such as hardness and fracture toughness are required.

DE 37 34 002 A1 describes a method for producing a component assembled of several parts from sintering iron or sintering steel, according to which blanks having bores and tappets are manufactured from iron or steel powder, the formed parts are put together to form a component and the parts are connected to one another in a materially bonded manner by depositing a magnetite layer on their surfaces. It is intended to thus be prevented that expensive solders have to be used which merely bedew the surface of the sintered component.

To the exact contrary, DE 44 04 406 A1 describes a solder for soldering porous sintering steels in which in the molten state, alloy constituents diffuse into the material and hence effect a solidification of the solder in the pores. A universally usable solder consists of 1 to 6 wt. % silicon, 0.1 to 1.5 wt. % boron, 0 to 25 wt. % iron, and 0 to 20 wt. % nickel, balance copper.

The underlying object of the present invention is to provide a possibility by means of which components consisting of sintering materials can easily be soldered under industrial conditions.

The object of the invention is achieved by means of the method mentioned initially, according to which that surface, which forms a part of the connection area, of the metallic component manufactured from the sintering material is compacted prior to the soldering.

The object is furthermore achieved by means of the assembly mentioned initially, in which the metallic component, which is manufactured from the sintering material, is surface-compacted in the connection area.

With the surface compaction of the connection area of the sintered component, the pores on the surface of the metallic component are closed. It can thus be achieved that a significantly lower amount of the solder or no solder at all enters the pores. Thus, a significantly lower amount of solder is used, as the solder is not drawn from the connection area, which would ultimately result in suffering of the connection quality. Moreover, this can also serve to avoid the increase in weight of the component as a consequence of the connection process, whereby, in further consequence, an increase of the weight acting on the connection site and thus also on the other component, can be avoided. Hence, an increase in weight in consequence of the further processing of the sintered component does not have to be taken into consideration already during the production of the sintered component, such that the selection of materials for the sintered component can be simplified and/or more possible sintering powders are available. Moreover, the fill of the solder on an industrial scale can thus be simplified, as no more fluctuations of the solder amount in the joint gap have to be feared.

Preferably, the compaction of the surface, which forms a part of the connection area, of the component manufactured powder-metallurgically from a sintering material is carried out to a density of at least 99.5% of the full material density, such that the component thus has at least 99.5% of the full material density in this area, to thereby further improve the aforementioned effects and/or increase the certainty that the solder does not infiltrate the sintered component or only infiltrates it to a negligibly small extent.

Preferably, the compaction of the surface, which forms a part of the connection area, of the component manufactured powder-metallurgically from a sintering material is carried out by means of blasting. This allows for relatively precise compaction of those areas that are required for creating the bond with the further component. The remaining areas of the sintered component can, in contrast, maintain their original properties.

Particularly preferred, a steel powder of stainless steel manufactured by means of gas atomization is used as blasting medium for blasting. This is due to the fact that it could be established in the evaluation of the invention that as compared to other blasting mediums, significantly higher compactions could be achieved with this blasting medium, such that the sintered component can have a density in this area which corresponds to 100% of the full density.

A copper solder is preferably used as the solder for soldering together the two metallic components. This solder proved to be beneficial in view of the industrial processing of sintered components, as it can be applied in paste form and then by means of simple temperature treatment be automatically inserted into the connection site in the molten state, without any manual manipulation being required for this.

According to another embodiment variant of the invention, it may be provided for that the metallic component, which is manufactured from the sintering material, comprises a compacted layer, having a layer thickness of between 50 μm and 350 μm, in the connection area. With a thus thick compacted surface layer of the sintered component, the certainty of avoiding the infiltration of the component with the solder can be increased, such that smaller damage of the surface of the component due to its manipulation during processing does not represent a problem for the improved connection formation.

For the aforementioned reasons, it may be provided for according to another embodiment variant of the assembly that the metallic component, which is manufactured from the sintering material, comprises a fraction of solder of at most 0.1 vol % in the connection area.

For the purpose of better understanding of the invention, it will be elucidated in more detail by means of the figures below.

These show in a respectively very simplified schematic representation:

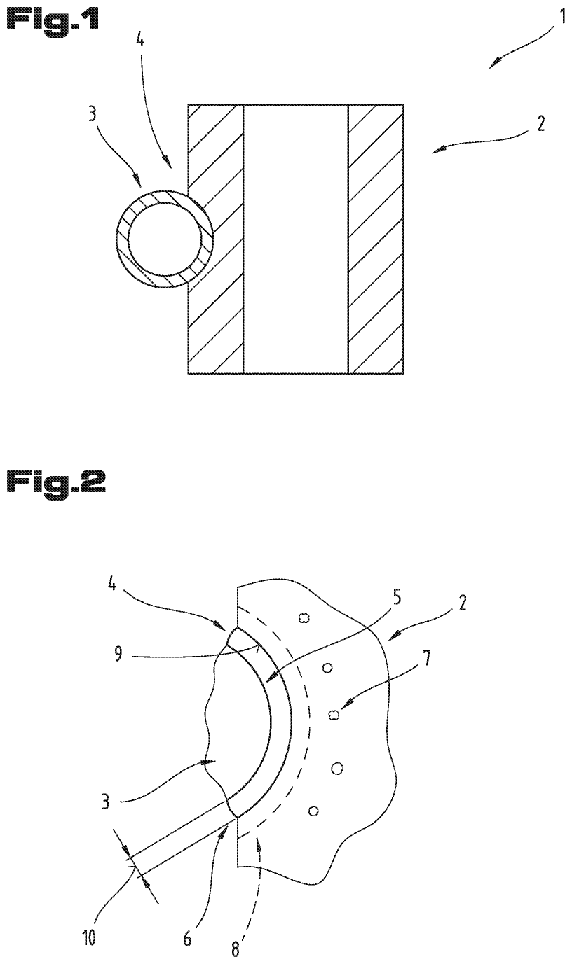

FIG. 1 a sectional view of an assembly of two metallic components;

FIG. 2 an enlarged detail of the assembly according to FIG. 1.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows an embodiment variant of an assembly 1, comprising and/or consisting of a first metallic component 2 and a second metallic component 3. At least one of the two components 2, 3 is manufactured powder-metallurgically from a sintering material. In the depicted embodiment variant, this is the first metallic component 2, which is a mounting element for the second metallic component 3, in particular a screw neck, for which it comprises a bore extending continuously in the direction of the longitudinal central axis for taking in a connection element, in particular a screw. The second metallic component 3 is a pipeline, for example a fuel line, in the depicted embodiment variant. Moreover, the second metallic component 3 or in general the component not manufactured powder-metallurgically (if not both metallic components 2, 3 are powder-metallurgically manufactured from a sintering material) can for example be a cast part, in particular consist of steel.

The assembly 1 or its metallic components 2, 3 can also be provided for a different application, for example for exhaust systems or lubricant pipes in plant construction.

The first metallic component 2 is connected to the second metallic component 3 by soldering. For this purpose, a connection area 4 (a joint gap) is formed between the two metallic components 2, 3, into which a solder 5 is taken in with which the materially bonded connection between the two metallic components 2, 3 is produced, as can better be seen from FIG. 2 showing the connection area 4 in larger representation.

It is to be noted at this point that the first metallic component 2 comprises an indentation for the partial intake of the second metallic component 3, as can be seen from FIGS. 1 and 2. In particular, this recess comprises a bending, which at least approximately corresponds to the bending of the second metallic component 3. However, the connection area 4 can also have a shape different from the one represented in FIGS. 1 and 2.

The first metallic component 2, or in general the powder-metallurgically manufactured component, can be manufactured according to a common sintering method. As said method is per se known, it is merely mentioned in this regard that this method comprises the steps of powder blending, powder compaction to a green compact, single- or multi-level sintering and optionally mechanical post-processing, such as deburring. The parameters that are to be used respectively are inter alia guided by the powder that is used and are known to the person skilled in the art, such that at this point, for the avoidance of repetitions, reference is made to the prior art in this regard.

Below, reference is made to a powder-metallurgically manufactured component, i.e. a sintered component, only. This also covers the first metallic component 2.

Subsequently to sintering, it is provided for that the powder-metallurgically manufactured component is compacted in the connection area 4. In principle, the compaction can also be performed more widely, such that not only a surface area 6 of the sintered component in the connection area 4 is compacted, but also adjacent areas. However, this is not obligatorily required for the formation of the connection between the two metallic components 2, 3, as no solder 5 is applied onto these sites.

The compaction of the surface area 6 of the powder-metallurgically manufactured component can be carried out according to different methods, for example pressing or rolling.

However, in the preferred embodiment variant of the method, the compaction is carried out by means of blasting of a blasting medium. By means of blasting, in addition to the compaction, by means of the cold working of the surface an increase in the hardness of the powder-metallurgically manufactured component can be achieved in this area.

For example scrap particles, gravel, etc. can be used as blasting medium. The particles of the blasting medium may have an elongated shape, a needle-like shape, an irregular shape, a polygonal shape, a round shape, an oval shape, etc.

However, particularly preferred, a steel powder of stainless steel manufactured by means of gas atomization is used as blasting medium for the aforementioned reasons.

The particles of the blasting medium can have a particle diameter selected from a range of 0.2 mm to 2 mm. In this regard, the particle diameter is that diameter of a sphere, into which the particle just fits.

The blasting medium can comprise particles of a particle size distribution between 0.2 mm and 2 mm. This can for example be provided by using one or several grading curve(s).

By the compaction of the surface area 6 of the powder-metallurgically manufactured component, a density that amounts to at least 95% of the full material density, however, at least 99.5% of the full material density according to an embodiment variant, may be achieved in this area. In this regard, the full material density is that density which the component would have in the connection area 4 if it were a void-free cast component, i.e. in other words the density of a pore-free component.

Particularly preferred, the surface area 6 has a density of at least 99.9% of the full material density. In particular, the density of the powder-metallurgically manufactured component in the surface area 6 forming a part of the connection area 4 amounts to 100% of the full material density. This is adumbrated in FIG. 2 by the surface area 6 not having any pores 7 which only occur below a dashed line 8 marking the end of the surface area 6.

The compacted surface area 6 extends from an outer surface 9, which forms a part of the connection area 4, of the powder-metallurgically manufactured component into a depth below this surface 9 amounting to at least 50 μm. It is preferably provided for according to an embodiment variant that the compacted surface area 6 comprises a layer thickness 10 amounting to between 50 μm and 350 μm, in particular between 100 μm and 150 μm. Such a high layer thickness of the compacted area can be achieved in particular by using the aforementioned steel powder manufactured according to a gas atomization method.

For manufacturing the powder-metallurgically manufactured component, a known metal powder (mixture) can be used. However, preferably, a steel powder is used, in particular a steel powder from a stainless steel or high-grade steel. The steel powder can for example have the composition 0 wt. % to 20 wt. % nickel, 1 wt. % to 25 wt. % chromium, 0 wt. % to 20 wt. % molybdenum, balance: iron. For example, the powder can comprise 18.5 wt. % Cr, 11.2 wt. % Ni, balance iron (oxygen maximum 0.22 wt. %, nitrogen maximum 0.05 wt. %, carbon maximum 0.02 wt. %). The common processing aids, such as compacting auxiliaries etc., as are per se known, can be admixed to the powder.

It is further possible that alloys with low melting points, such as tin alloys, are used as the solder 5. However, according to a further embodiment variant, a copper solder is particularly preferred. In this regard, the term “copper solder” also comprises copper alloys that can be used as the solder 5.

The solder 5 can for example be applied as a paste onto the first and/or the second metallic component 2, 3. For a higher degree of automation, the solder 5 can at least partially be applied onto at least one of the two metallic components 2, 3 outside of the connection area 4. By heating the solder 5 at least to the melting temperature, for example in a continuous furnace, the solder 5 can flow into the connection area 4 and form the connection between the two metallic components 2, 3 after cooling. For this purpose, the two metallic components 2, 3 are correspondingly positioned to one another and held with a holding device, in particular already before the application of the solder 5.

According to a further embodiment variant, it can be provided for that the metallic component, which is manufactured from the sintering material, in the connection area 4 in the surface area 6 comprises a fraction of solder of at most 0.1 vol %, in particular of 0 vol %.

Preferably, the powder-metallurgically manufactured component is cleaned after the compaction, in particular blasting compaction, and prior to the soldering. Cleaning is in particular carried out by means of thermal cleaning in an H₂ atmosphere. This cleaning serves the purpose of freeing the surface of the component from oxides as far as possible. A temperature of between 800° C. and 1200° C. is suggested for carrying out this cleaning.

Tests have been carried out for evaluating the connection quality. For this purpose, two metallic components 2, 3 connected to one another by means of a copper solder were clamped and the breaking force was measured. One of the two components consisted of a cast steel, the other one of a steel powder which was processed powder-metallurgically. For measuring the breaking force, the force acting onto the connection area 4 was increased until the assembly 1 broke. In all cases, the powder-metallurgically manufactured components itself broke, not the connection area 4. In the course of this, forces of approximately 2,600 N were measured.

The exemplary embodiments show and/or describe possible embodiment variants, while it should be noted at this point that combinations of the individual embodiment variants are also possible.

Finally, as a matter of form, it should be noted that for ease of understanding of the structure, elements are partially not depicted to scale and/or are enlarged and/or are reduced in size.

### LIST OF REFERENCE NUMBERS

1 assembly

2 component

3 component

4 connection area

5 solder

6 surface area

7 pore

8 line

9 surface

10 layer thickness

1. A method for producing a connection between a first metallic component (2) and a second metallic component (3), wherein at least one of the two metallic components (2, 3) is manufactured powder-metallurgically from a sintering material and the connection is produced by means of soldering in a connection area (4) formed between the two metallic components (2, 3), wherein the surface (9), which forms a part of the connection area (4), of the metallic component (2 or 3) manufactured from the sintering material is compacted prior to the soldering.

2. The method according to claim 1, wherein the compaction of the surface (9), which forms a part of the connection area (4), of the component (2 or 3) manufactured powder-metallurgically from a sintering material is carried out to a density of at least 99.5% of the full material density.

3. The method according to claim 1, wherein the compaction of the surface (9), which forms a part of the connection area (4), of the component (2 or 3) manufactured powder-metallurgically from a sintering material is carried out by means of blasting.

4. The method according to claim 3, wherein for blasting, a powder of stainless steel manufactured by means of gas atomization is used as blasting medium.

5. The method according to claim 1, wherein a sintering powder of stainless steel is used as sintering material.

6. The method according to claim 1, wherein a copper solder is used as solder.

7. An assembly (1) comprising a first metallic component (2) and a second metallic component (3), wherein at least one of the two metallic components (2, 3) is manufactured powder-metallurgically from a sintering material, and the two components (2, 3) are soldered to one another with a solder (5) in a connection area (4), wherein the metallic component, which is manufactured from the sintering material, is surface-compacted in the connection area (4).

8. The assembly (1) according to claim 7, wherein the metallic component (2 or 3), which is manufactured from the sintering material, comprises a surface density of at least 99.5% of the full material density in the connection area (4).

9. The assembly (1) according to claim 7, wherein the metallic component (2 or 3), which is manufactured from the sintering material, comprises a compacted layer, having a layer thickness (10) of between 50 μm and 350 μm, in the connection area (4).

10. The assembly (1) according to claim 7, wherein the metallic component (2 or 3), which is manufactured from the sintering material, comprises a fraction of solder of at most 0.1 vol % in the connection area (4).
